(19) United States
(12) Patent Application Publication
(10) Pub. No.: US 2019/0124840 A1
(43) Pub. Date: May 2, 2019

(54) Harvesting Technique for Separate Collection and Processing of Leafy/Flower-Budded Crop Canopy and Remnant Lower Stalks

(71) Applicant: Lyall D. Bates, Gilbert Plains (CA)

(72) Inventor: Lyall D. Bates, Gilbert Plains (CA)

(21) Appl. No.: 16/137,130

(22) Filed: Sep. 20, 2018

Related U.S. Application Data
(63) Continuation-in-part of application No. 16/119,167, filed on Aug. 31, 2018.

(51) Int. Cl. A01D 45/06; A01D 34/835; A01D 43/06; A01D 43/08; A01G 22/00

(52) U.S. Cl. CPC A01D 45/065; A01D 34/8355; A01G 22/00; A01D 43/08; A01D 43/06

(57) ABSTRACT

A unique method of harvesting hemp plants is useful to isolate the leafy/flower-budded crop canopy from lower stalks of the plants to enable separate collection thereof, whereby CBD rich leaves/buds of the canopy can be processed more efficiently at an off-site facility. The harvesting method includes performing a first cutting operation at an elevated cutting height, during which the tops of the plants are detached from remnant lower stalks left standing in the field, and the detached plant tops are laid in a windrow or collected in an accompanying collection receptacle. A second cutting operation performed over the same field area at a lower cutting height serves to cut the lower stalks from the field and lay these cuttings into a separate windrow that is entirety isolated from the cut plant tops. This enables separate storage, transport and post-harvest processing of the different materials.

### CROSS-REFERENCE TO RELATED APPLICATIONS

This application is a continuation-in-part of application Ser. No. 16/119,167, filed Aug. 31, 2017, the entirety of which is incorporated herein by reference.

### FIELD OF THE INVENTION

The present invention relates generally to crop harvesting techniques, and more particularly to harvesting techniques in which the leafy/flower-budded tops of the plants are cut first, before subsequently cutting down a remnant lower stalk of plant.

### BACKGROUND

Applicant has previously proposed unique processes for post-harvest processing of hemp plants in order to derive various vendible products from the constituent components of the plants, including the bast fiber, shive, leaves and flower buds. The details of these processes are described in Applicants prior U.S. Pat. Nos. 9,707,567; 9,855,562; 10,052,636 and related U.S. patent application Ser. No. 16/018,604, all of which are incorporated herein by reference in their entirety. Among these processes are those aimed at producing granular products containing both bast fiber and shive from the stalk of the hemp plant, and processes aimed at extracting cannabinoid (CBD) from the leaves and flower buds thereof. In the '604 application, Applicant's post-harvest processing of the plant includes separation of the leaves and flower buds from the stalk of whole plants that were harvested from the field in a fully intact form, and baled and transported to the processing facility in such state. Through such separation, the CBD rich leaves and flower buds can be sold or further processed independently of the bast fiber and shive of the stalks, which contain significantly lesser concentrations of CBD oil and are useful in the manufacture of various other vendible products.

However, there remains room for improved and alternative techniques for isolating the leaves and flower buds of the hemp plant from the other constituent components thereof.

### SUMMARY OF THE INVENTION

According to one aspect of the invention, there is provided a method of harvesting crop plants from a field, said method comprising:
over a first area of said field,
(a) performing a first cutting operation comprising:
   (i) at a first cutting height elevated above ground level, cutting plant tops from plants of said first area while leaving remnant lower stalks of the plants of said first area standing in the field; and
(b) performing a second cutting operation comprising:
   (i) cutting said remnant lower stalks of the plants of said first area at a lower second cutting height nearer to ground level, thereby separating cuttings of said remnant lower stalks from underlying roots of the plants; and
   (ii) laying said cuttings into a stalk windrow that is separate and isolated from the plant tops cut in the first cutting operation.

The first cutting operation may comprise laying said plant tops in a plant top windrow, from which the stalk windrow laid in the second cutting operation is separate and isolated.

In such dual-windrow embodiments in which both the plant tops and remnant stalk cuttings are windrowed, step (a)(ii) preferably comprises laying the plant top windrow outside the first area of the field.

Dual-windrow embodiments may include, after completion of steps (a) and (b) over the first area of the field, performing a repetition of steps (a) and (b) over a second area of the field, and in step (a)(ii) of said repetition, laying the plant top windrow from the second area of the field atop the first area of the field.

The method may include performing said first and second cutting operations with respective first and second machines respectively operating at said first and second cutting heights, whereby the first cutting operation is performed in a first pass over said first area by the first machine, and the second cutting operation is performed in a second pass over said first area by the second machine.

In dual-windrow embodiments, the method may include:
performing steps (a)(i) and (b)(i) with respective first and second cutterbars that respectively reside at said first and second cutting heights, and that have respective first and second cutting widths; and
laying the plant top and stalk windrows in steps (a)(ii) and (b)(ii) with respective first and second windrow outlets, of which the first windrow outlet is positioned at a more outboard location relative to the first cutting width than the second windrow outlet is positioned relative to the second cutting width.

Preferably the first windrow outlet is situated adjacent an end of the first cutting width.

Preferably the second windrow outlet is situated intermediately between opposing ends of the second cutting width.

In dual-windrow embodiments, step (a)(ii) preferably comprises laying the plant top windrow outside the first area of the field.

As an alternative to dual-windrow embodiments, the first cutting operation may be performed with a cutter bar whose travel over the first area is accompanied by a collection receptacle into which the plant tops severed by the first cutter bar are dispensed as said cutter bar travels over the first area.

In said alternative embodiment, there is preferably a conveyor that spans between the cutter bar and the collection receptacle and is operable to convey the severed plant tops from the cutterbar to the collection receptacle.

In said alternative embodiment, the collection receptacle is preferably towed alongside the first area.

In said alternative embodiment, the collection receptacle and the cutterbar may be components of separately conveyed implements driven in concert with one another along the first area of the field.

Step (b)(ii) preferably comprises laying the stalk windrow atop the first area of the field.

Preferably the method includes collecting the plant tops and the stalk windrow from the field separately of one another.

The method may include leaving the plant tops and the stalk windrow in the field for different respective lengths of time before collection.

All cutting operations may be performed by machinery other than a combine harvester.

The first and second cutting operations may lack any threshing of the crop between the cutting and windrowing steps.

Preferably the tops of said plants comprise leaves and/or flower buds, and the remnant lower stalks and the cuttings thereof are substantially free of leaves and flower buds.

The crop preferably comprises hemp plants, of which the tops of the plants comprise leaves and/or flower buds, and the remnant lower stalks and the cuttings thereof are substantially free of leaves and flower buds.

The method may include transporting the plant tops and the cuttings to respective first and second destinations that are located remotely of the field and from which the plant tops and the cuttings are queued for intake to different first and second processing sequences respectively configured to derive different vendible products from the plant tops and the cuttings.
the first and second destinations may reside at separate first and second processing facilities, of which the first processing facility is equipped to at least partially complete the first processing sequence on the plant tops, and the second processing facility is equipped to at least partially complete the second processing sequence on the cuttings.

When the crop comprises hemp plants, preferably the first processing sequence is operable to extract CBD oil from leaves and/or flower buds of the plant tops.

When the crop comprises hemp plants, the remnant lower stalks and the cuttings therefrom comprise bast fiber and shive and are substantially free of leaves and flower buds, and the second processing sequence is preferably operable to derive one or more vendible products from the bast fiber and/or shive of the cuttings.

The second processing sequence may lack a preliminary leaf and flower bud separation stage in view of the absence of leaves and flower buds in the cuttings received by said processing sequence.

### BRIEF DESCRIPTION OF THE DRAWINGS

Preferred embodiments of the invention will now be described in conjunction with the accompanying drawings in which:

FIG. 1 is a schematic overhead view of a field of whole hemp plants ready for harvest, and a first crop cutting machine prepared make a first pass across the field at a first area thereof during a first embodiment harvesting technique of the present invention.

FIG. 2 schematically shows the first crop cutting machine making a first pass over the first area of the field, during which the leafy/flower-budded plant tops are cut therefrom and laid in a first windrow alongside the first area.

FIG. 3 schematically shows the field once the first crop cutting machine has completed the first pass over the first area of the field.

FIG. 4 is another schematic overhead view of the field, but with a second crop-cutting machine prepared to make a second pass over the first area of the field.

FIG. 5 schematically shows the second crop cutting machine making a second pass over the first area of the field, during which remnant lower stalks of the plants previously left standing by the first crop-cutting cutting machine are cut from the field and laid in separate second windrow.

FIG. 6 schematically shows the field once the second crop cutting machine has completed the second pass over the first area of the field.

FIG. 7 is another schematic overhead view of the field, but with the first crop cutting machine prepared to make a first pass over a second area of the field.

FIG. 8 schematically shows the first crop cutting machine making a first pass over the second area of the field, during which the leafy/flower-budded plant tops are cut therefrom and laid in new windrow atop the previously cut first area.

FIG. 9 is another schematic overhead view of the field, but with the second crop cutting machine prepared to make a second pass over the second area of the field.

FIG. 10 schematically shows the second crop cutting machine making a second pass over the second area of the field, during which remnant stalks of the plants left standing in the second area by the first crop-cutting cutting machine are cut from the field and laid in another new windrow.

FIG. 11 schematically shows the field once the second crop cutting machine has completed the second pass over the second area of the field.

FIG. 12 schematically shows the field once all areas thereof have been subject to passes by the first and second crop cutting machines.

FIG. 13 schematically shows the field of FIG. 12 during bailing and collection of separate windrows containing the leafy/flower-budded tops of the hemp plates and the remnant stalk cuttings thereof.

FIG. 14 schematically illustrates a first pass over the first area of the field during a second embodiment harvesting technique of the present invention, in which the leafy/flower-budded plant tops are collected as they are cut, rather than being laid in a windrow.

FIG. 15 schematically illustrates a first pass over the second area of the field during the second embodiment harvesting technique.

FIG. 16 schematically shows the field of FIG. 15 during bailing of windrowed remnant stalk cuttings from the field once all areas thereof have been fully cleared.

### DETAILED DESCRIPTION

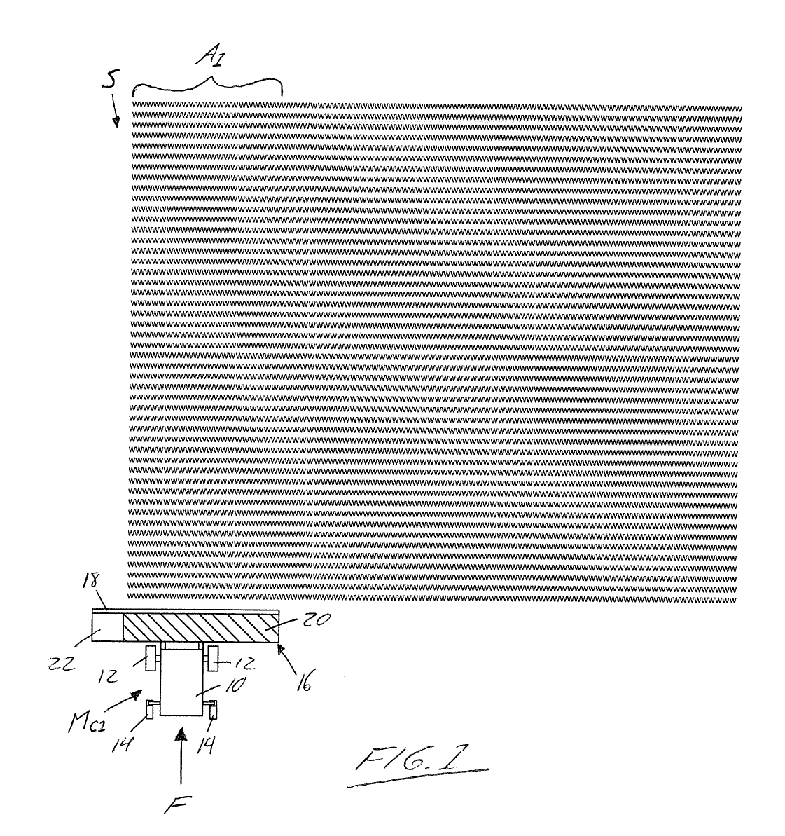

FIG. 1 schematically illustrates a field containing a crop of hemp plants ready to harvest, schematically represented by the letter “W” to reflect a “whole” or intact state of each plant in the field prior to the performance of any of the cutting or harvesting steps described herein further below. In this initial whole state of the plant, a stalk of the plant emerges upwardly from the soil and underlying root of the plant, and carries leaves and/or flower buds at only an upper portion of the stalk. Meanwhile, a lower portion of the stalk is fully or substantially bare of any such leaves and/or flower buds. Accordingly, the leaves and/or flower buds reside only at spaced elevations above ground level. This leafy/flower-budded upper portion of each plant is referred to herein more simply as the “top” of the plant in the interest of brevity, and the collective tops of the plants are referred to herein as the canopy of the crop. The bare lower portion of each plant stalk however, consisting only or substantially of the stalk, is referred to herein more simply as the “remnant lower stalk” of the plant. Below is described a novel harvesting technique by which the tops of the plants and the remnant lower stalks thereof can be collected separately from one another, for example in the interest of reducing post-harvest processing equipment requirements at off site processing facilities situated remotely of the crop field.

FIG. 1 illustrates a first crop cutting machine M_{C1} which for example may take the form of a self-propelled swather (also known as a windrower), which is composed of a front-cabin rear-engine tractor 10 having driven front wheels 12, rear caster wheels 14, and a header 16 (also known as a table or platform) that is carried at a front end of the tractor 10 and spans thereacross in a lateral direction perpendicularly transverse to a forward working direction F in which the tractor is conveyed by rotation of its driven wheels 12. The header 16 features a cutterbar 18 that is located at a leading front edge thereof, and spans an entirety or substantial majority of the header width, as measured in the lateral direction from one end of the header to the other. Trailing the cutterbar in the forward working direction F is a lateral conveyor 20 for receiving cut crop material from the cutterbar 18 and conveying this material laterally to a windrow outlet 22 situated at one end of the header 16 in outboard relation from the tractor 10. The length of the cutterbar 18 across the leading front edge of the header 16 defines the cutting width of the first crop cutting machine M_{C1}, which for clarity is referred to herein as the “first cutting width” to distinguished it from the cutting width of the second crop cutting machine referenced below.

FIG. 1 shows the first crop cutting machine M_{C1} in an aligned working relation to a first area A₁ of the field. In this aligned working relation, the cutting width of the first crop cutting machine M_{C1} spans fully across a width of the first area A₁, as measured perpendicularly of the forward working direction F in which the first crop cutting machine M_{C1} will traverse the first area A₁ of the field. In the illustrated example, this first area A₁ resides adjacent a perimeter boundary of the larger overall field area occupied by the targeted harvest-ready hemp plants. This first area A₁ thus neighbours an adjacent margin space S of the field that is substantially unoccupied by the targeted hemp plants. In the aligned working position, a majority width of the header of the first crop cutting machine M_{C1} spans widthwise across the first area A₁ of the field, while a small remainder of the header 16 of the first crop cutting machine M_{C1} overhangs the margin space S by at least the width of the windrow outlet 22. As a result, the entirety of the windrow outlet 22 overlies the margin space S and not the first area A₁ of targeted crop plants. The cutterbar height of the first crop cutting machine M_{C1} is set at a suitable elevation above ground level to cut only the tops of the whole hemp plants W, for example to cut an uppermost 24-inches or less of the plants.

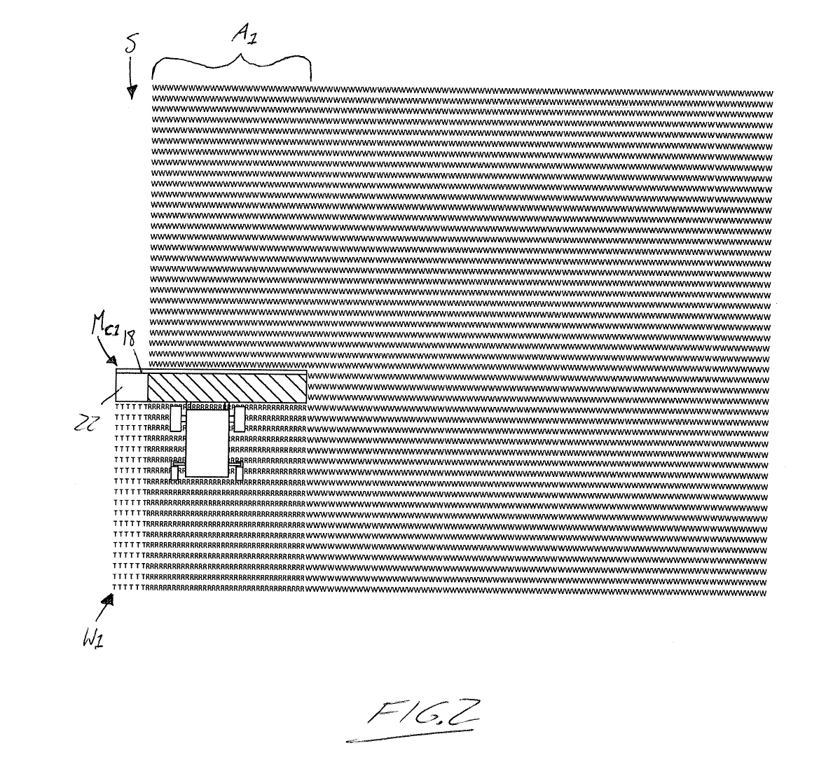

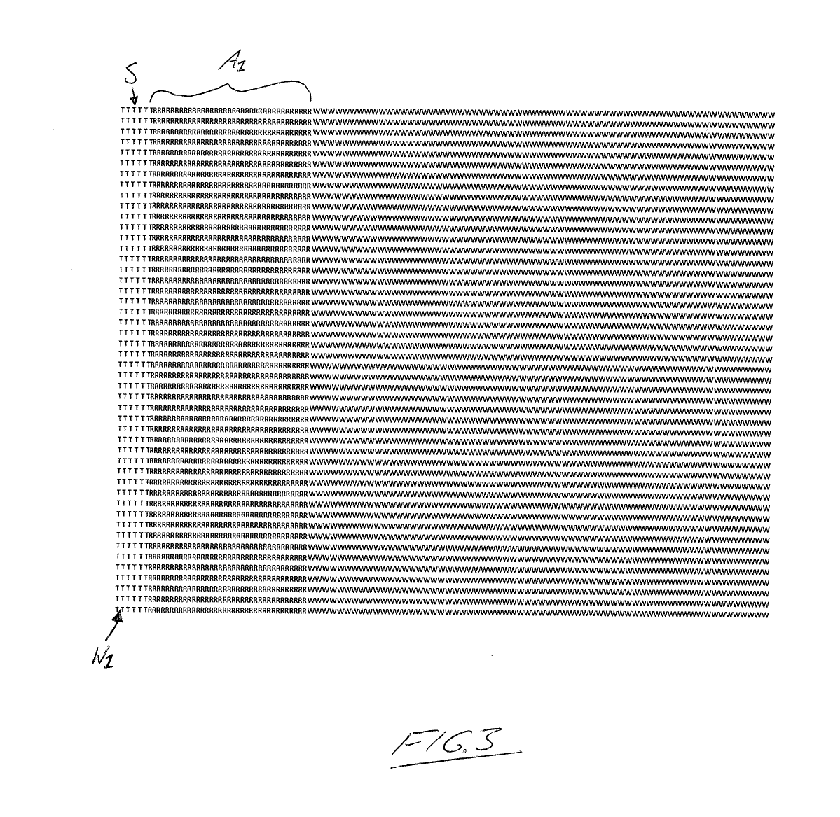

With reference to FIG. 2, the first crop cutting machine M_{C1} is driven in a first pass over the first area A₁, during which the aligned working relation is maintained so that the cutterbar acts on the targeted crop of the first area, while the windrow outlet 22 instead passes over the margin space S of the field. This way, the severed tops of the hemp plants, schematically represented by the letter “T”, are laid in a first windrow W₁ atop the unoccupied margin space S of the field. Since only the tops T of the whole hemp plants W are being cut in this first pass over the first area A₁ of the field, the first cutting operation performed by the suitably elevated cutterbar of the first crop cutting machine M_{C1} leaves the remnant lower stalks of the cut plants behind in the first area A1 of the field. FIG. 3 shows the resulting status of the field after the first pass by the first crop cutting machine M_{C1}, where the first area A₁ is now occupied only by remnant lower stalks, schematically represented by the letter “R”, while all the severed plant tops T from the first area A₁ have been cleanly laid in a first windrow W₁ atop the previously unoccupied margin space S of the field.

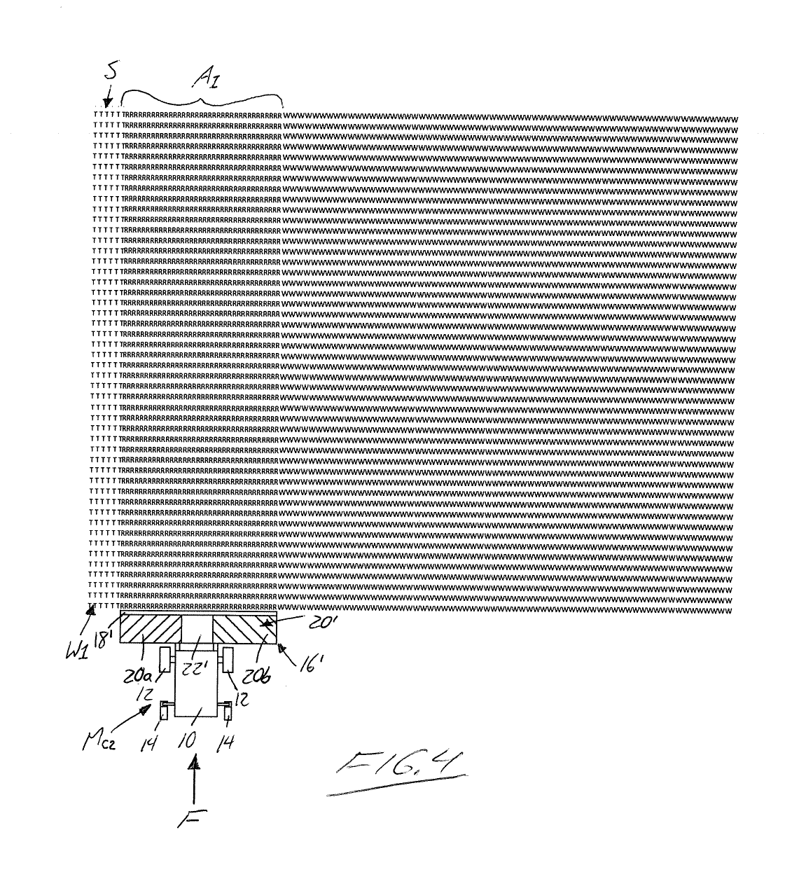

Turning to FIG. 4, a second crop cutting machine M_{C2} is shown for the purpose of performing a second cutting operation on the remnant lower stalks R of the first area A1 in a second pass thereover. Like the first crop cutting machine M_{C1}, the second crop cutting machine M_{C2} may be a self-propelled swather, and is likewise equipped with a cutterbar 18′ of sufficient length to span fully across the first field area A₁ in the width direction thereof. The second crop cutting machine M_{C2} differs from the first however, in that its cutterbar is set to a lower cutting height of closer elevation to the ground, and its windrow outlet 22′ is situated more centrally of the second machine's header than the outboard windrow outlet 22 of the first crop cutting machine M_{C1}. This central windrow outlet 22′ of the second machine M_{C2} thus resides between two directionally opposite halves 20a, 20b of the lateral conveyor 20′ of the second crop cutting machine M_{C2}. This way, crop material severed from the field by the cutterbar of the second crop cutting machine M_{C2} is diverged inwardly toward the center of the header 16′ by the two oppositely directed conveyor halves 20a, 20b, where this cut crop material is laid in a central windrow through the central windrow outlet 22′. As a result, the aligned working position of the second crop cutting machine M_{C2} is one in which its cutterbar spans the full width of the currently targeted field area A₁, while its windrow outlet 22′ also resides over this same field area A₁, and not an adjacent area or space outside the currently targeted area.

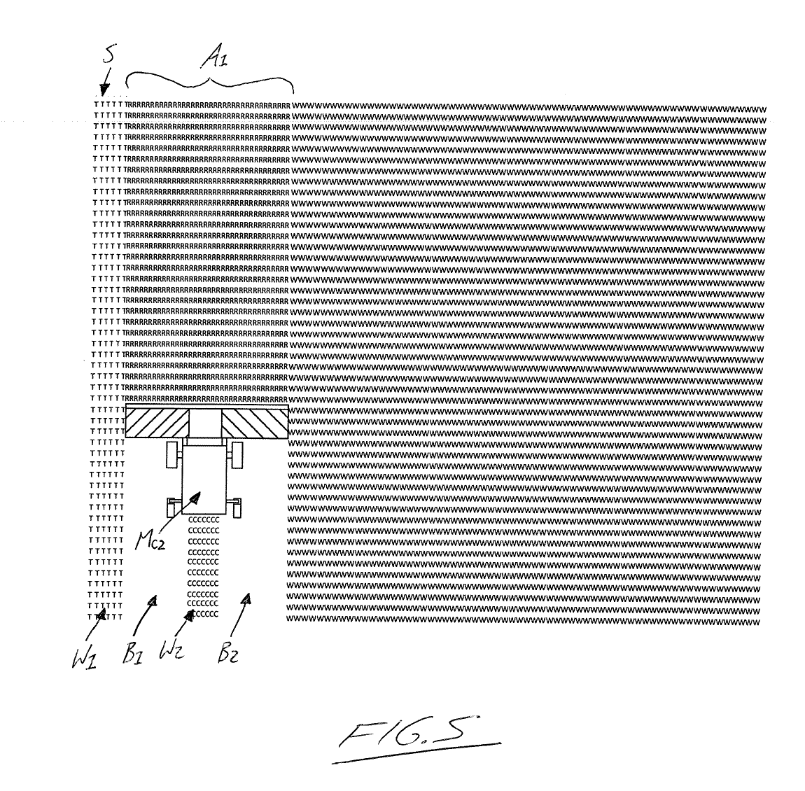

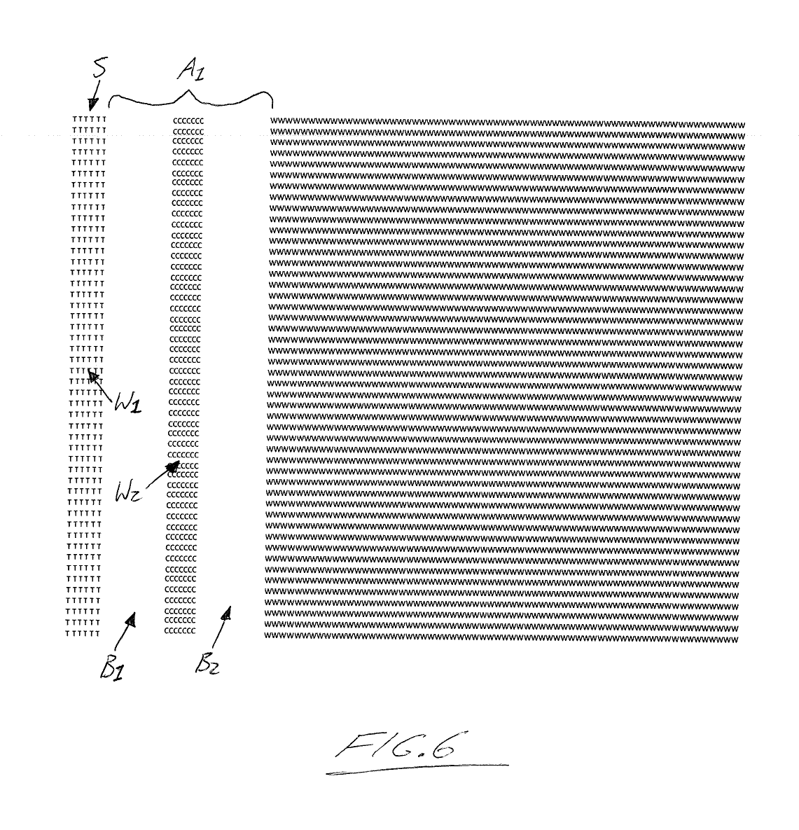

FIG. 5 illustrates passage of the second crop cutting machine M_{C2} over the first area A₁, where the lower cutterbar of the second crop cutting machine cuts the remnant lower stalks R left behind in the first pass by the first crop cutting machine. More specifically, the second crop cutting machine M_{C2} cuts these remnant stalks R in close relation to the ground so as to remove the entirety or substantial majority of the remnant stalks from the field. These full or substantial cuttings of the remnant stalks, represented by the letter “C” in the figures, are conveyed inwardly to the central windrow outlet 22′ of the second crop cutting machine M_{C2}, thus laying these cuttings C down into a second windrow W₂ positioned centrally of the first area Aₜ. This second windrow W₂ of remnant stalk cuttings C is thus located entirely separate of the first windrow W₁ of severed plant tops T that were previously laid down in the margin space S of the field during the first pass performed by the first crop cutting machine M_{C1}. The white spaces on either side of the second windrow W₂ in FIGS. 5 and 6 thus represent empty bands B₁, B₂ of the first area A₁ that are unoccupied by the severed plant tops T and remnant stalk cuttings C from the first and second passes of the first area A₁.

FIG. 6 shows the field after completion of the second pass of the first area A₁, where all of the originally whole hemp plants W of this first area A₁ have been cut down in a two-stage cutting process, and the resulting severed tops T and remnant stalk cuttings C have been laid atop the ground in two separate and distinct windrows W₁, W₂ that enable separate subsequent collection of the leafy/flower-budded tops T from the bare remnant stalk cuttings C.

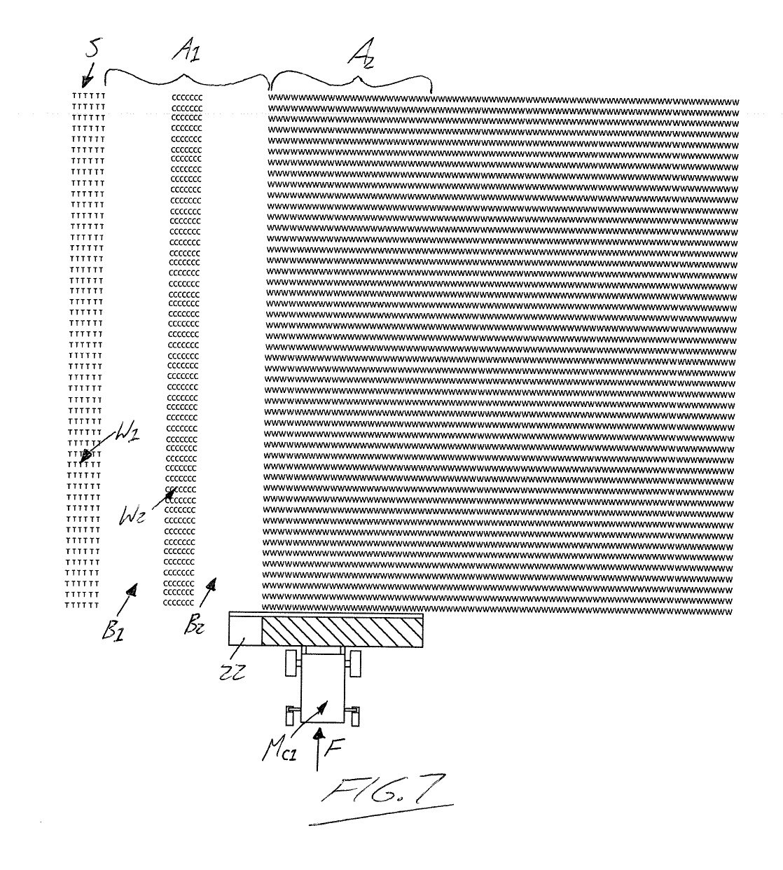

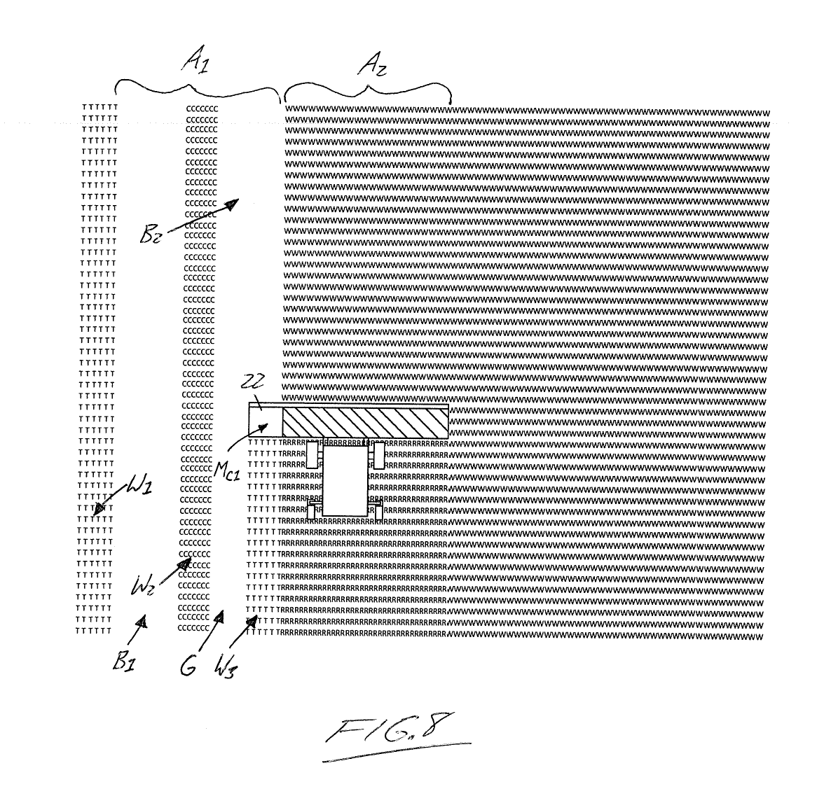

FIGS. 7 through 11 illustrate repetition of the same two-stage cutting process on an adjacent second area A₂ of the field that immediately neighbours the first area A₁ on the side thereof opposite the margin space S of the field. FIG. 7 shows positioning of the first crop cutting machine M_{C1} into aligned working relation with the second area A₂ so that the cutterbar of the machine spans the full width of the second area A₂. However, instead of overhanging the margin space S of the field, the header 16 of the first crop cutting machine overhangs the previously cleared first area A₁ of the field. This way, with reference to FIG. 8, the outboard windrow outlet 22 of the first crop cutting machine M_{C1} overlies the previously cleared first area A₁ so that as the first machine M_{C1} makes a first pass over the second area A₂, the severed plant tops T from this second area A₂ are laid in a third windrow W₃ atop the previously cleared first area A₁. More specifically, the severed plant tops T from the second area A₂ are windrowed at a boundary region of the first area A₁ that is situated closely adjacent the second area A₂. This leaves a notable gap G between this newly formed third windrow W₃ and the previously laid second windrow W₂ containing the remnant stalk cuttings C from the first area A₁. In other words, the one of the previously unoccupied bands B₂ of the fully cleared first area A₁ nearest to the second area A₂ now being cleared is used to accommodate the windrowing of the severed tops T from the second area A₂, specifically at a side of this band B₂ furthest from the previously laid windrow W₂ of the first area's remnant stock cuttings.

The relative sizing of the windrow openings of the crop cutting machines to the cut width of each field area is selected to accommodate such spacing apart of the different windrows in non-overlapping relation to one another. For example, in one embodiment the area cut width of each field area is 25-feet, and the windrow spread width dictated by the windrow opening of each machine is 5-feet. The first machine's header width thus corresponds to the sum of the area cut width and the windrow spread width so that the first machine's windrow can be laid outside the area currently being cut. This way, the windrow of severed plant tops T is laid atop an unoccupied margin space or previously cut field area rather than atop of the remnant stalks R being left behind in the current cutting operation. So, the particular example given above, the area cut width is 25-feet, and the first machine has a header width of 30-feet and windrow spread width of 5-feet, while the second machine has a header width of 25-feet and windrow spread width of 5-feet. This way, half the area cut width (12.5 feet) of any field area is enough to accommodate half of the central windrow of remnant stalk cuttings C (2.5 feet) from that area, plus the full width of the outboard windrow of severed tops T from the next area (5 feet), while still leaving a notable gap space G (5 feet) between these two windrows.

The cutterbar length (i.e. cutting width) of the second crop cutting machine M_{C2} spans the full header width of that machine, while the cutterbar length (i.e. cutting width) of the first crop cutting machine M_{C1} can either span the full header width of that machine, or only 25-feet of its 30-feet, as cutting is not required directly in front of the windrow outlet 22 of the first machine since this windrow outlet overlies an unoccupied margin space or previously cut area of the field during any given pass of the first crop cutting machine M_{C1}. In non-numerical terms, the cutting width of the first crop cutting machine M_{C1′} is: (a) at least as great as the cutting width of the second machine M_{C2}; and (b) at least as great as the difference between the overall header width of the first machine M_{C1} and the windrow spread width of the first machine M_{C1}. Expressed in alternative terms, the first machine M_{C1} has a header width at least as great as the sum of the second cutting machine's cutting width and the first cutting machine's windrow spread width.

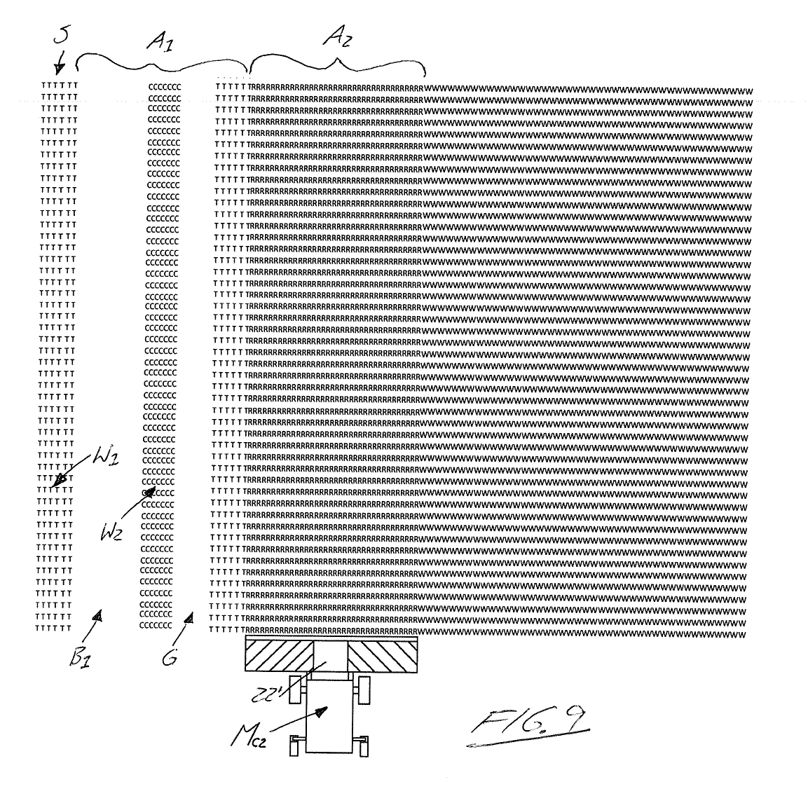

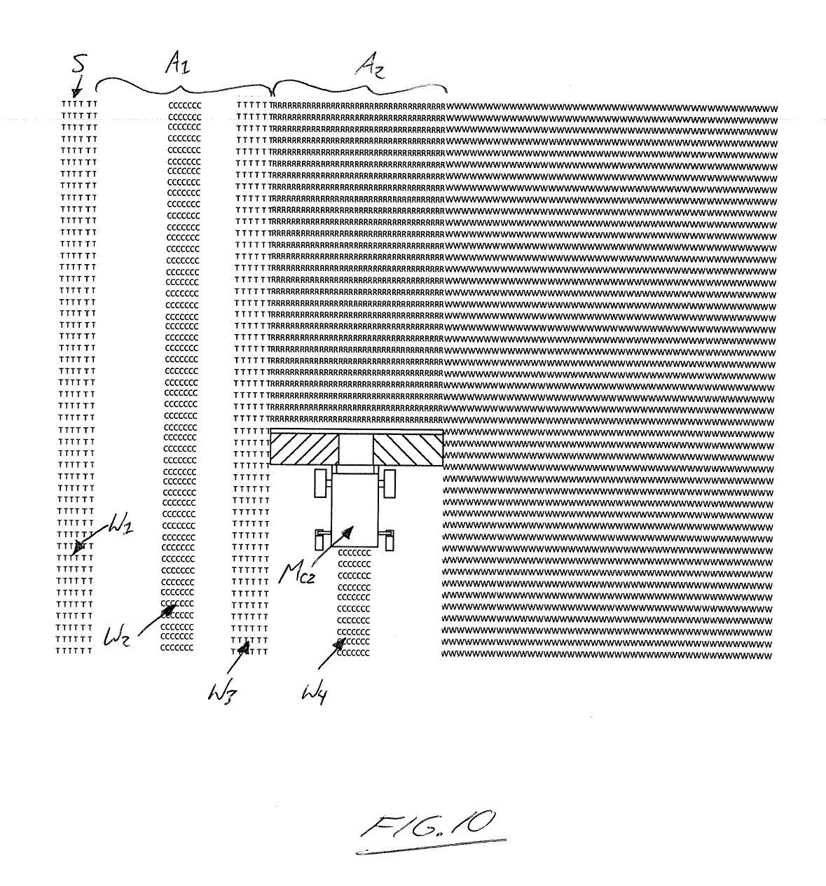

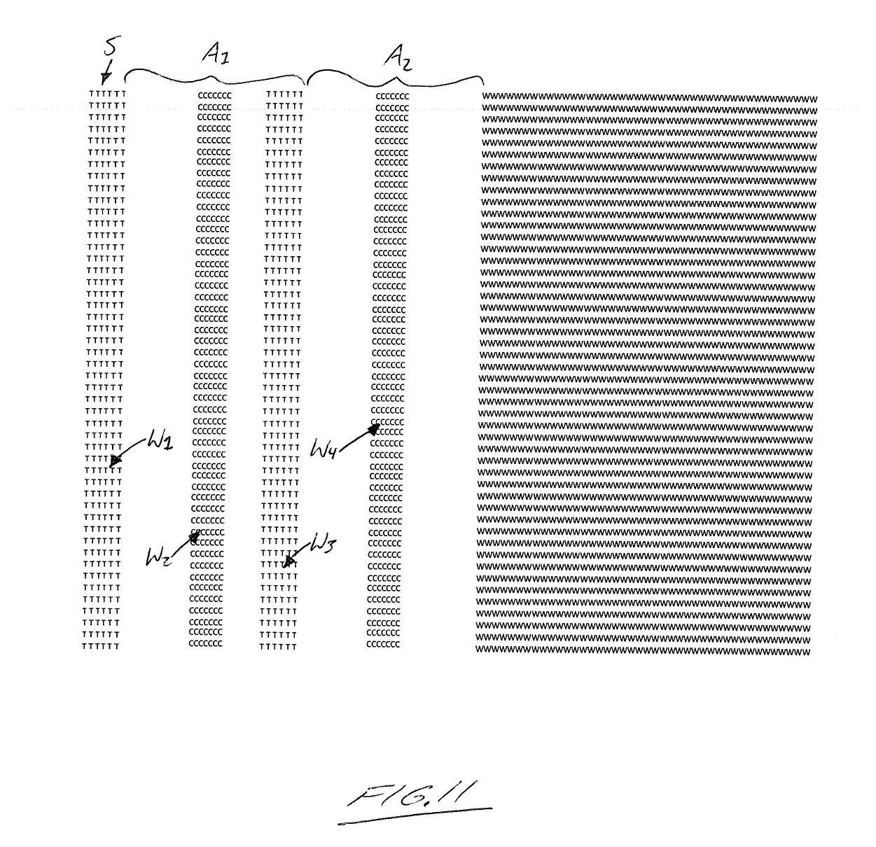

Referring to FIGS. 9 and 10, the second cutting machine M_{C2} makes a second pass over the second area A₂ of the field, thus cutting down the remnant lower stalks R of the plants and laying them in a fourth windrow W₄ running centrally of the second area A₂. FIG. 11 shows the state of the field once the second area A₂ has been fully cleared by respective passes of the two cutting machines. This two-pass process is repeated for the third area A₃ and any subsequent areas A₄ of the field until the entire field is cleared.

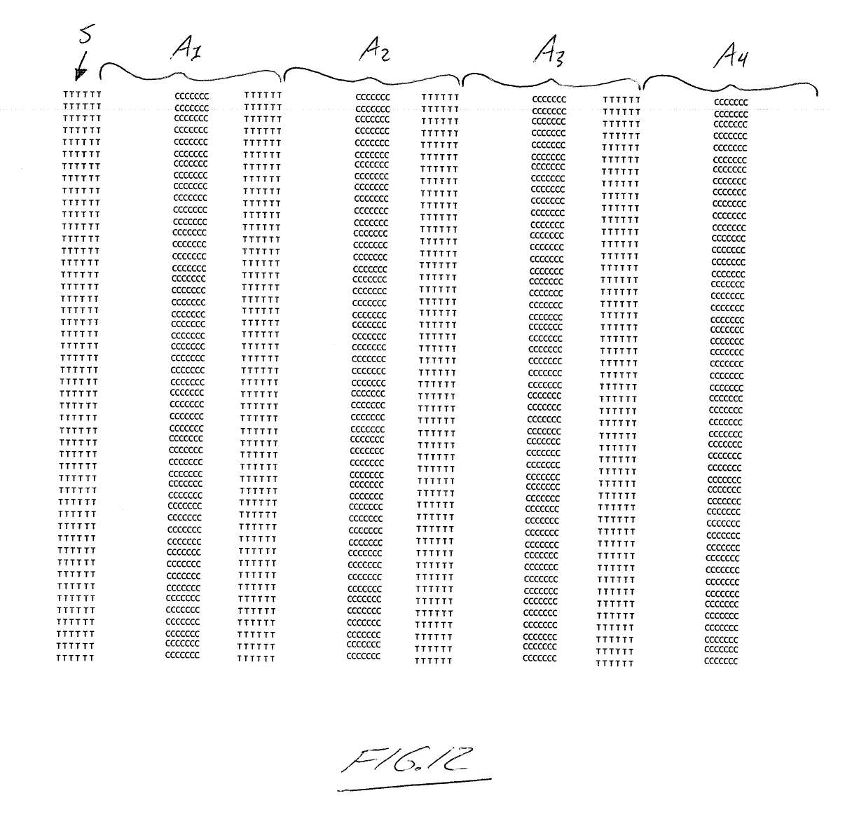

So, at each of the second and subsequent areas, a first pass made by the first cutting machine M_{C1} cuts the tops T of the plants and lays them in a first windrow atop the precedingly cleared area, and a second pass made by the second machine M_{C2} cuts the remnant lower stalks R and lays these cuttings in a second windrow atop the area currently being cut. FIG. 12 shows four fully cleared areas A₁, A₂, A₃, A₄, where the first through third areas A₁-A₃ are each occupied by one central windrow of remnant stalk cuttings C from that area, plus one boundary-adjacent outer windrow of plant tops T from the subsequently cut neighbouring area. The first and last areas A₁ and A₄ are each occupied only by a central windrow of remnant stalk cuttings C, but the first area A₁ is also neighboured by a windrow W₁ of plant tops T laid in the margin space S of the field. So for field cleared in N number of areas, areas A₁-A_{N-1} are each occupied by one central windrow of remnant stalk cuttings C from that area, plus one boundary-adjacent outer windrow of plant tops T from the subsequently cut neighbouring area A₂-A_{N}, while the first and last areas A₁ and A_{N} are each occupied by only a central windrow of remnant stalk cuttings C.

While the illustrated embodiment employs self-propelled swathers for the crop cutting machinery, any other piece of machinery suitably equipped to both cut and windrow the crop may be used. Examples include a tractor carried swather attachment, mower, mower-conditioner, etc. If the hemp processing facility for which the plant tops T are destined is already equipped with suitable equipment for separating the leaves and flower buds from the upper stalks of the plant tops, then use of swather, mower or mower-conditioner machines lacking any threshing components is preferable over use of a combine harvester with threshing means, though a combine harvester with an internal thresher may nonetheless still be used. While the illustrated embodiment employs separate cutting machines for the two cutting operations, other embodiments may employ a novel cutting machine that has an elevated first header whose cutterbar is situated in elevated and leading relation to the cutterbar of a lower second header, and that has an outboard windrow outlet on the elevated first header and a more central windrow outlet on the lower second header.

Once all the plant tops and remnant stalk cuttings have been cut and windrowed, as shown in FIG. 12, one or both of the windrow types may be promptly collected from the field with no or minimal delay, or one or both of the windrow types may optionally be left in the field to dry out for a period time before collection or baling.

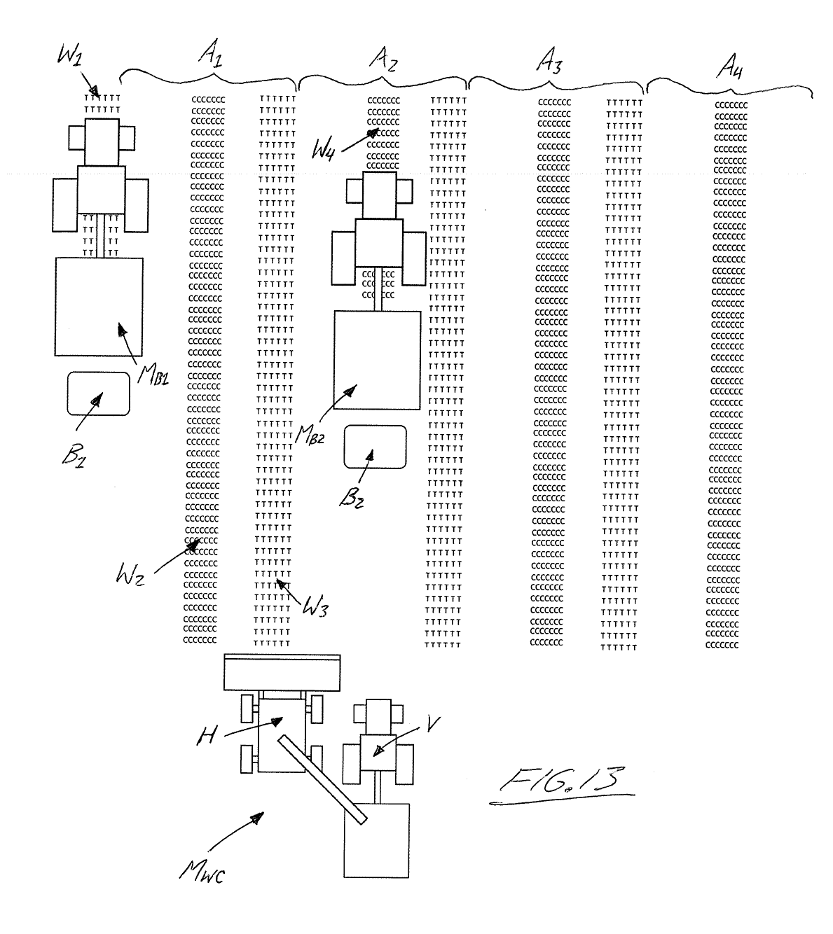

FIG. 13 illustrates optional pickup of one or both windrow types by one or more baling machines M_{B1}, M_{B2}. For example, a first baling machine M_{B1} may pick up the cut plant tops T from the plant top windrows and drop bales B₁ of plant tops in the field, while a second baling machine M_{B2} picks up the remnant stalk cuttings C and drops bales B₂ of remnant stock cuttings in the field. While use of separate baling machines for baling the plant tops and the remnant stalk cuttings allows increased efficiency by simultaneously running multiple machines in the field, collection of both materials by the same machine in separate baling/collecting operations may alternatively be employed.

In addition to baling of the remnant stalk cuttings, and in addition or alternative to baling at least some of the plant tops, a silage harvester H (also known as a forage harvester) and accompanying collection wagon towed by the harvester H or an accompanying tractor or other vehicle V, may be used as a non-baling windrow-collecting machine M_{WC} for collecting the plant tops T from at least some of the plant top windrows. Alternatively, a self-loading forage/silage wagon may be used as the non-baling windrow-collecting machine M_{WC}, thus avoiding the need for both a wagon and separate harvester H.

In one scenario, the plant tops and remnant stalk cuttings are collected by one or more windrow-collecting machines M_{WC} with zero or minimal delay, for example within 24-hours or less of the windrows being laid. In such instance, a windrow-collecting machine may trail shortly behind the second crop cutting machine M_{C2} in its passes across the field. The harvester-accompanying wagon, or self-loading wagon, may be used to transport the collected remnant stalk cuttings to a remote processing facility, or the cuttings may first be transferred from the wagon to one or more other suitable transport containers for shipment to the remote facility.

In another scenario, the windrows of plant tops are left in the field for an extended length of time, for example 7 to 9 days, to notably dry the plant tops out to a moisture content of 18% or lower, at which time the windrowed plant tops are then baled in round or square bales. The bales can stored locally at the field location or at an intermediate location before delivery to a remote hemp processing facility, where CBD oil and other potentially valuable oils, chemicals or other constituent materials can be extracted or separated for use as, or in, various vendible products.

In another scenario, the windrows of plant tops are left in the field over a shorter period, for example two days or less, to dry out to a moisture content of 50-60%, and then baled in round or square bales, which may be bagged or wrapped, for example in plastic stretch film, to store the bales in a substantially air tight manner limiting exposure of the bales to oxygen. Again, the bales can stored locally at the field location, or at an intermediary location, before delivery to a remote hemp processing facility, where CBD oil and other potentially valuable oils, chemicals or other constituent materials can be extracted or separated for use as or in various vendible products.

In any of the forgoing scenarios, the windrows of remnant stalk cuttings C may be left in the field for a notable amount of time, for example 10 to 14 days, to dry out to a moisture content of 15% or less before baling.

The remote hemp processing facility suitably equipped to perform a first processing sequence on the plant tops to extract CBD or other valuable constituent materials therefrom may be an all-in-one facility that is also be suitably equipped to perform a second processing sequence on the remnant stalk cuttings to make use of the bast fiber and/or shive of the plant stalk, in which case both the plant tops and the remnant stalk cuttings can be delivered to the same hemp processing facility. The plant tops and remnant stalk cuttings may be delivered together in a singular shipment, though in an unmixed state (e.g. in their separate bales, or in separate containers if unbaled), and then separated again at the processing facility, where the baled or unbaled plant tops are queued for intake to the first processing sequence, while the remnant stalk cuttings are queued for intake to the second processing sequence. Alternatively, the plant tops and remnant stalk cuttings may be delivered separately, for example to different receiving docks of the same facility, from which they are queued for intake into the respective processing sequences.

In other instances, the plant tops and the remnant stalk cuttings may be delivered to two separate facilities, including a first processing facility suitably equipped to perform the first processing sequence on the plant tops, and a separate second processing facility suitably equipped to perform the second processing sequence on the remnant stalk cuttings. In either instance, the second processing sequence can be simplified by omitting or reducing labour or mechanized means for separating leaves and/or flower buds from the stalks, since the received remnant stalk cuttings are substantially or entirely bare as a result of the inventive harvesting techniques employed in the field.

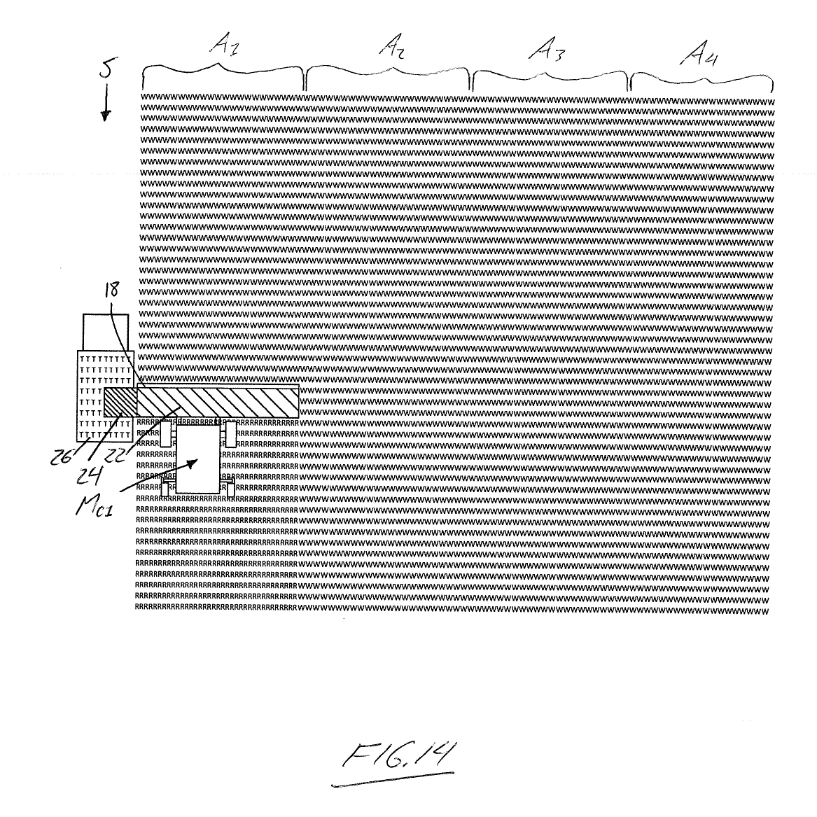

FIGS. 14 through 16 illustrate a second embodiment, which differs from the above described embodiment of FIGS. 1 through 15 in that instead of the first crop cutting machine M_{C1} having a windrow outlet at the outboard end of its cutter bar, it instead has an upwardly inclined conveyor 24 that is fed by the lateral conveyor 20 and lifts the cut plant tops T upwardly to the open top end of a travelling collection receptacle 26 being conveyed alongside the first area A₁ of the field in the neighbouring margin space S thereof. In this embodiment, the plant tops are thus instantaneously collected during the cutting operation, rather than being laid on the field in a respective windrow. The collection receptacle 26 may for example be defined by top-load box of a grain truck, trailer or wagon being driven or towed across the field in concert with the first cutting machine. In this particular example, the cutterbar 18 of the first crop cutting machine severing the plant tops and the collection receptacle 26 into which the plant tops T are dispensed are therefore components of separately conveyed implements. Alternatively, it may be possible to have the collection receptacle 26 towed by the first cutting machine M_{C1}, preferably in offset relation thereto so that the collection receptacle rides alongside the area being cut in laterally offset relation thereto so as not to trample the remnant stalks left behind the first cutting machine M_{C1}. So during the first pass over the first area A₁ of the field, the collection receptacle is conveyed over the margin space S of the field.

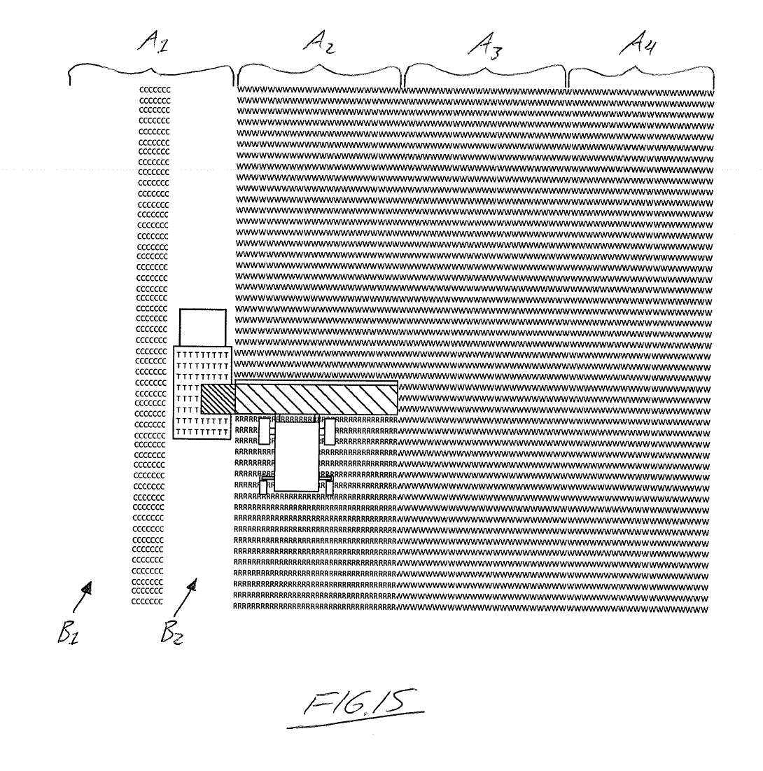

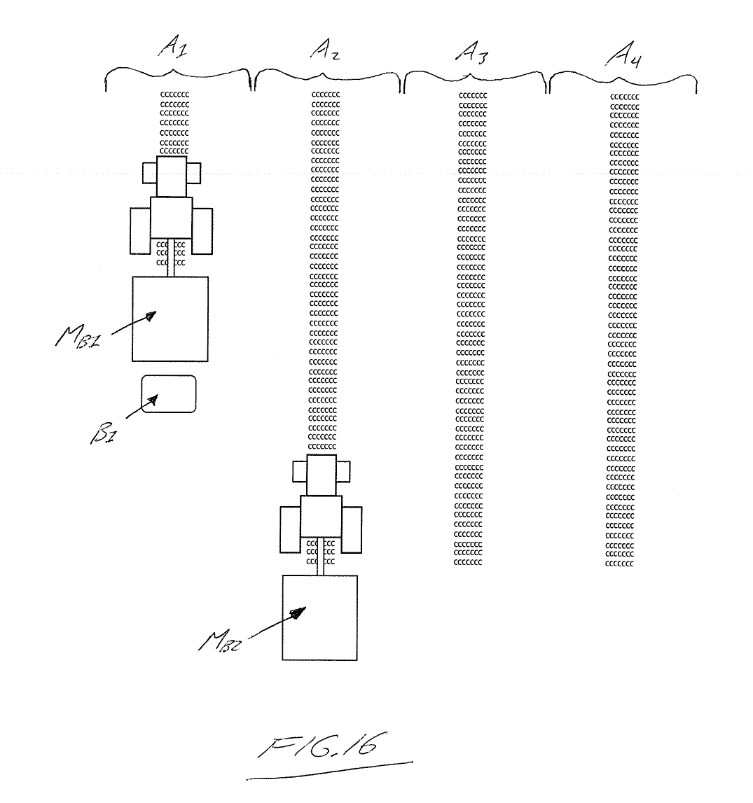

The second crop cutting machine M_{C2} makes a second pass over the first area A₁ of the field in the same manner described for the earlier embodiment, thereby fully clearing the first area of the originally standing crop. FIG. 15 shows the first crop cutting machine M_{C1} then making a first pass over the second area A₂ of the field, during which the collection receptacle 26 rides over the fully cleared first area A₁ of the field in one of the unoccupied bands B₁, B₂ thereof so as not to disrupt the centrally laid windrow of stalk cuttings C in the first area A₁. In this embodiment, the windrow outlet 22′ of the second crop cutting machine M_{C2} may be set to a more outboard location in order to increase the with of the unoccupied band B₂ between the windrow of stalk cuttings C and the next field area to be cut, thereby better accommodating travel of the collection receptacle 26 through this unoccupied band B₂ as the first crop cutting machine M_{C1} traverses that next area of the field. FIG. 16 shows the same field area as FIGS. 14 and 15 once all areas thereof have been fully cleared, thus leaving only a singular windrow in each and every area of the field, and more specifically only a windrow of remnant stalk cuttings C without a corresponding windrow of plant tops T. These remnant stalk cuttings are then baled types by one or more baling machines M_{B1}, M_{B2} in the same manner described for the earlier embodiment.

Since various modifications can be made in my invention as herein above described, and many apparently widely different embodiments of same made, it is intended that all matter contained in the accompanying specification shall be interpreted as illustrative only and not in a limiting sense.

1. A method of harvesting crop plants from a field, said method comprising:
over a first area of said field,
(a) in a first pass over said first area of the field with a first machine, performing a first operation comprising:
(i) removing leaves and/or flower buds from plants of said first area; and
(b) in a second pass over said first area of the field with a second machine, performing a second operation comprising:
(i) cutting stalks of the plants of said first area near ground level, thereby separating cuttings of said stalks from underlying roots of the plants; and
(ii) laying said cuttings into a stalk windrow that is separate and isolated from the leaves and/or flower buds removed from the plants in the first operation.

2. The method of claim 1 wherein the first operation comprises cutting plant tops, containing said leaves and/or flower buds, from said plants at a first cutting height above ground level while leaving remnant lower stalks of said plants standing in the field in step (a)(i), and further comprises step (a)(ii) of laying said plant tops in a plant top windrow, from which the stalk windrow laid in the second operation is separate and isolated, and wherein the second operation comprises cutting said remnant lower stalks at a lower second cutting height nearer to ground level.

3. The method of claim 2 wherein step (a)(ii) comprises laying the plant top windrow outside the first area of the field.

4. The method of claim 2 comprising after completion of steps (a) and (b) over the first area of the field, performing a repetition of steps (a) and (b) over a second area of the field, and in step (a)(ii) of said repetition, laying the plant top windrow from the second area of the field atop the first area of the field.

5. (canceled)

6. The method of claim 2 comprising:
performing steps (a)(i) and (b)(i) with respective first and second cutterbars of the first and second machines that respectively reside at said first and second cutting heights, and that have respective first and second cutting widths; and
laying the plant tops and stalk windrows in steps (a)(ii) and (b)(ii) with respective first and second windrow outlets, of which the first windrow outlet is positioned at a more outboard location relative to the first cutting width than the second windrow outlet is positioned relative to the second cutting width.

7. The method of claim 6 wherein the first windrow outlet is situated adjacent an end of the first cutting width.

8. The method of claim 6 wherein the second windrow outlet is situated intermediately between opposing ends of the second cutting width.

9. The method of claim 1 wherein the first operation is performed with a header of the first machine whose travel over the first area is accompanied by a collection receptacle into which the leaves and/or flower buds are dispensed as said header travels over the first area.

10. The method of claim 9 wherein a conveyor spans between the header and the collection receptacle.

11. The method of claim 9 wherein the collection receptacle is towed alongside the first area.

12. The method of claim 9 wherein the collection receptacle and the header are components of separately conveyed implements driven in concert with one another along the first area of the field.

13. The method of claim 2 further comprising collecting the plant tops and the stalk windrow from the field separately of one another.

14. The method of claim 13 comprising leaving the plant tops and the stalk windrow in the field for different respective lengths of time before collection.

15. The method of claim 1 wherein step (b)(ii) comprises laying the stalk windrow atop the first area of the field.

16. The method of claim 1 wherein, upon completion of the first pass, the plants are substantially free of leaves and flower buds.

17. The method of claim 1 wherein the crop comprises hemp plants, which upon completion of the first pass, are substantially free of leaves and flower buds.

18. The method of claim 1 comprising transporting the leaves and/or flower buds to a first destination that is remote from the field, where said leaves and/or flower buds are queued for intake to a first processing sequence configured to derive at a least a first vendible product, and transporting the cuttings to a different second destination that is also remote from the field, where said cuttings are queued for intake to a second processing sequence configured to derive at a least a different second vendible product.

19. The method of claim 18 wherein the first and second destinations reside at separate first and second processing facilities, of which the first processing facility is equipped to at least partially complete the first processing sequence on the leaves and/or flower buds, and the second processing facility is equipped to at least partially complete the second processing sequence on the cuttings.

20. The method of claim 18 wherein the crop comprises hemp plants, and the first processing sequence is operable to extract CBD oil from the leaves and/or flower buds.
